(19) United States
(12) Patent Application Publication
(10) Pub. No.: US 2018/0335321 A1
(43) Pub. Date: Nov. 22, 2018

(54) Data collection system and method

(71) Applicant: Resource International Inc., Columbus, OH (US)

(72) Inventors: Kamran Majidzadeh, New Albany, OH (US); Bernard Schubach, New Albany, OH (US)

(73) Assignee: Resource International Inc., Columbus, OH (US)

(21) Appl. No.: 15/292,522

(22) Filed: Oct. 13, 2016

(51) Int. Cl. G01D 9/00; G06F 17/30

(52) U.S. Cl. CPC G01D 9/00; G06F 17/30283

(57) ABSTRACT

Disclosed is a method for inspecting physical structures for inspection, data condition collection, data administration, analysis, and reporting. The method includes (a) inspecting the physical structure; (b) entering into a mobile data collector with memory, wireless communications, and analysis software, a unique identification indicia of the physical structure including name, identification indicia, global positioning system (GPS) location, condition rating, and color coding based on the condition rating; the unique identification indicia being sent by the wireless communications to a database server; (c) analyzing with the analysis software based upon the data entered into the mobile data collector and established rating manual criteria, the general appraisal (GA) number for the inspected physical structure.

### CROSS-REFERENCE TO RELATED APPLICATIONS

This application is cross-referenced to commonly owned application Ser. No. 14/175,262 filed Feb. 7, 2014, the disclosure of which is expressly incorporated herein by reference.

### STATEMENT REGARDING FEDERALLY SPONSORED RESEARCH

Not applicable.

### BACKGROUND

The present disclosure relates to inspection of physical structures and locations along with data collection and reporting and more particularly to an intelligent data collection system and method that is integrated with a web-based file storage and management, dynamic schedule system, financial management, red lining/revision control, photo album views, public access, tiered security, RFI system, and more.

As exemplified by roadways, including signage, guardrails, curbs, litter, and the like, there is a need to perform inspections, often for safety. Moreover, there also is a need to have a record or history of such items along with a record of repairs. There is a further need to be able to authorize such inspections along with approval of repairs when needed.

In the same way, there also is a need to inspect a variety of physical structures or facilities including, inter alia, buildings, bridges, parking lots, parking garage structures, rails, runways, and the like. It is to such needs that the present disclosure is addressed.

### BRIEF SUMMARY

Disclosed is a method for inspecting physical structures for inspection, data condition collection, data administration, analysis, and reporting. The method includes (a) inspecting the physical structure; (b) entering into a mobile data collector with memory, wireless communications, and analysis software, a unique identification indicia of the physical structure including name, identification indicia, global positioning system (GPS) location, condition rating, and color coding based on the condition rating; the unique identification indicia being sent by the wireless communications to a database server; (c) analyzing with the analysis software based upon the data entered into the mobile data collector and established rating manual criteria, the general appraisal (GA) number for the inspected physical structure.

### BRIEF DESCRIPTION OF THE DRAWINGS

For a fuller understanding of the nature and advantages of the present method and device, reference should be had to the following detailed description taken in connection with the accompanying drawings, in which:

FIG. 1 shows the various data stored in memory and other features of the disclosed handheld device;

FIG. 2 illustrates various physical assets and their geotagging, as displayed by the disclosed handheld device;

FIG. 3 also illustrates various physical assets, such as guardrails, signage of the roadway features and their geotagging, as displayed by the disclosed handheld device;

FIG. 4 is an example of landslide of a pavement, roadway feature;

FIG. 5 is graphically displays the subjective rating field values versus the disclosed empirical equations disclosed herein for bridge decks;

FIG. 6 graphically displays the subjective rating field values versus the disclosed empirical equations disclosed herein for a bridge decks identified by “self-audit” check:

FIG. 7 graphically displays the subjective field values versus the disclosed empirical equations disclosed herein for a culvert;

FIGS. 8A and 8B are a flow sheet of the software in the portable data collector for the general appraisal of a bridge deck;

FIG. 9 is a flow sheet of the general appraisal; and

FIG. 10 is a flow sheet of the software in the portable data collector for the general appraisal of a culvert.

The device referred to is a portable electronic device carried by the field inspector when making a ground field inspection.

The drawings will be described in greater detail below.

### DETAILED DESCRIPTION

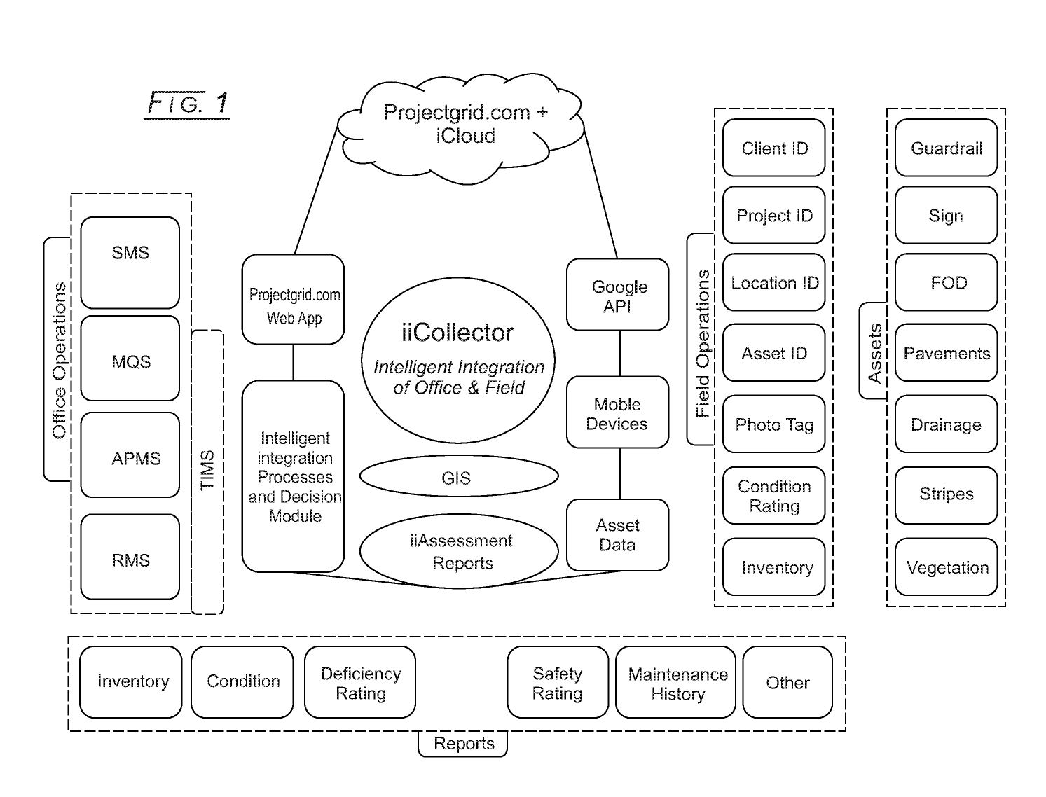

The iiCollector™ technology is an intelligent integration of office and field documentation, accessible via mobile devices. A part of an interactive, password-protected, project and program management website is a flexible customizable asset management system to rate all infrastructure assets, such as, for example, transportation, utilities, and facilities. It easily integrates with various GIS platforms, as well as management systems. Using a GPS-enabled (global positioning system) and web-enabled handheld device, such as a tablet, it is possible to rate the elements in the field, and the ratings will get stored in a secure electronic database from which they can be imported into another tool. The ratings also can be viewed directly in the website. The ratings are stored in a secure electronic database where users can use tools to view, analyze, and output the data. The stored ratings include the longitude and latitude of the point where the rating was taken to whatever precision the handheld device supports. FIG. 1 illustrates this integration of web and intelligent field data collector.

This innovative software is a web-based solution for asset inspection, data condition collection, data administration, analysis, and reporting. It has real time access to relevant ASTM, AASHTO (The American Association of State Highway and Transportation Officials) and DOT (department of transportation) manual and standards of operations such as MQS (Maintenance Quality Standards), MCR (Maintenance Condition Rating), BMS (Bridge Maintenance System), PMS (Pavement Management System), TIMS (Total Information Management System), etc. The software also can inspect and record infrastructure asset inventory and condition data using the mobile intelligent data collector. The infrastructure assets that can be included in an intelligent mobile data collector and analyzer include all aspects of transportation, facilities, and utilities.

The data collector/analyzer has unique features absent in other mobile asset management units. For example, this technology has integrated a decision/intelligent module. As a result, the collector unit assists the field inspectors and office engineers with their decision making process by presenting estimated ratings, in real-time, using knowledge-based system equations.

The data collector/analyzer has four distinctly different sub sections, which are presented below. The first one is not much different from other data collectors, except that it is a web-based system.

### A. Collector Unit Web App Standard Field Data Acquisition

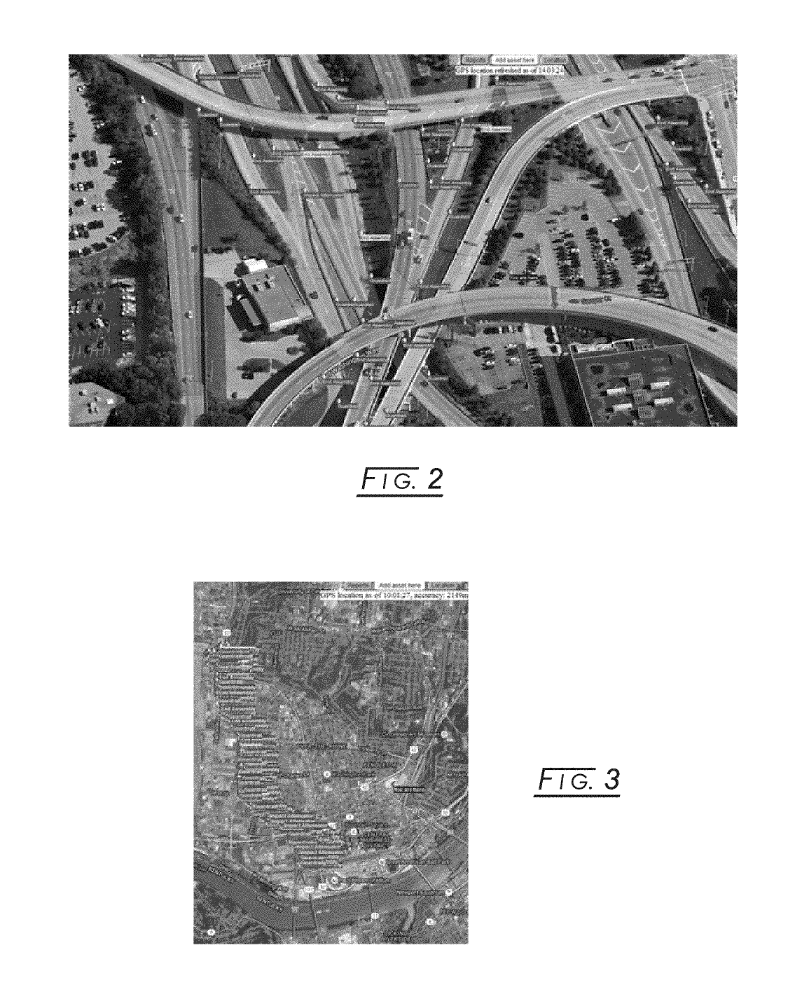

Similar to any advanced mobile data collection device, the field condition and inventory data are collected rated, color coded, geo-tagged, photographed, and transferred to a designated web-site database. The Internet website serves as a host database, where at a later time the data could be maintained permanently, transferred to a client's server or other systems, etc. Examples of such capability are shown in FIG. 2.

All assets are geo-tagged, color coded by the condition, and displayed on a map app. The inspector photographs the assets. Each asset type is identified by name, ID number, GPS, milepost, etc. The condition rating of assets could follow any specification or manuals of operation, such as, for example, city, DOT's, AASHTO, ASTM (American Society for Testing and Materials), FAA (Federal Aviation Administration), FHWA (Federal Highway Administration), MQS (Maintenance Quality System), or other rating methods. The ratings could be expressed as, for example:

No deficiencies (0)-Deficient (1)

Satisfactory-Unsatisfactory.

Acceptable-Barely-Unacceptable.

Poor-Fair-Good.

The mobile unit assigns a color to the rated asset based on an assigned standard for the particular asset being rated. See FIG. 3. A report of asset condition and inventory and all relevant field data becomes available on, for example, a spreadsheet app, as the data is saved on the mobile web-app device.

Separate reports are presented for different asset types, and with the description and the inspector's comments relevant to the asset inventory and condition. The field data and the geo-tagged assets are displayed on a mobile map app and are available to be shared with office personnel on a real time basis worldwide. Moreover, the field personnel could communicate with the office staff while the data is being collected.

B. Data Collection Unit with Real-Time Access to Office Documents “Intelligent Integration”

A unique feature of the mobile data collection unit is the intelligent integration of office documents and field operations. In most highly critical projects, such as those dealing with rating of roadside safety features, such as, for example, guardrails, signs, stripes, pavement, and landslides, the accessibility to office documents, manuals, and project specifications, for example, is essential. Having access to such office documents enhances the speed and accuracy of field inspection and condition rating.

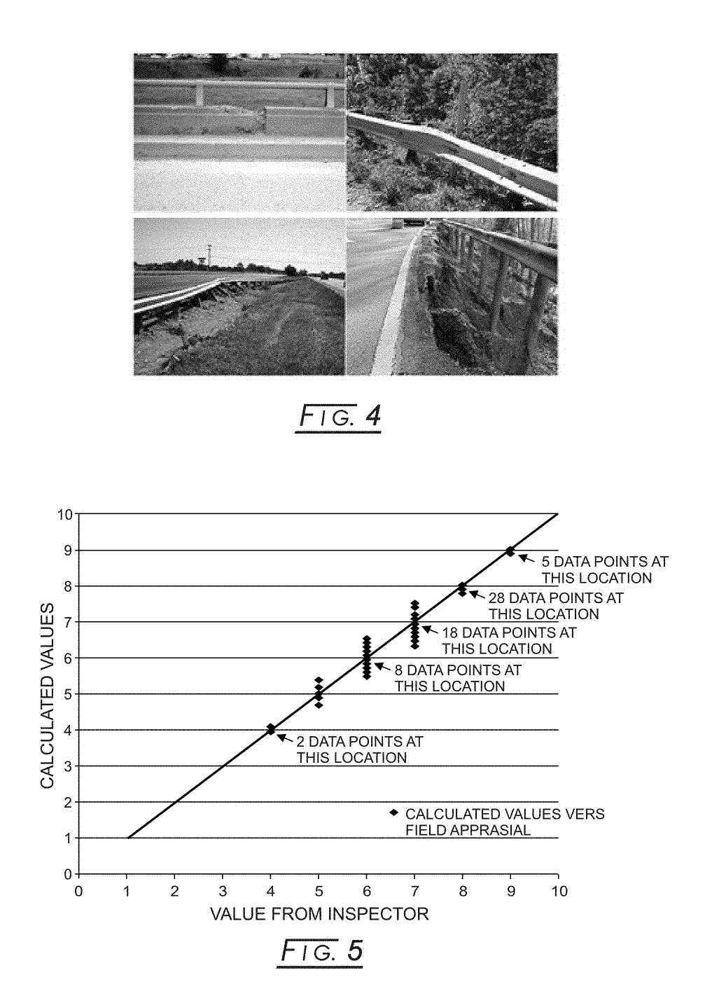

The mobile web-app technology, through the intelligent integration capability, gives the inspectors in the field real-time access to relevant governing specifications or manuals of operations during the data collection process. The mobile web based solution capability provides real-time accessibility to any documents or manuals available to public, such as, for example, DOT's (Department of Transportation) asset condition manuals, specifications, design equations, which are only relevant to the subject asset. The relevant sections of manuals or specifications are pre-loaded and stored in the web-app system and a symbol is displayed along with the asset for a real-time access in the field. This capability could be used for any asset for which rating manuals and rating documents and specifications are accessible. The examples in FIG. 4 are guardrail survey, sign, stripes, and all roadside features.

C. Portable Data Collector with Real-Time Analysis Software for Calculating the Asset's Condition

There are many assets, such as, for example, guardrails, signs and traffic devices, which have more than one element and each is rated separately, as satisfactory (0) or unsatisfactory (1). There is no requirement for a general appraisal of the over condition rating, however for assets such as, for example, bridges, culverts, pavement, or retaining walls. It is required to have an overall condition rating or General Appraisal (GA) of the asset. To develop such an overall condition state, the condition of each element should be rated and combined into a single number. This general appraisal rating is achieved either by analytical means or by subjective expressions.

This advanced portable data collection unit is empowered with analysis software uniquely designed to convert the individual condition rating of various elements. Additionally, it can assess any asset and calculate an overall number representative of the condition state or a general appraisal rating of that asset. Many infrastructure assets could be only rated if each individual component or element of the asset are rated and summed by its relative significance or weight.

A pavement structure or a landslide (see FIG. 4) may exhibit several individual distresses, where each has to be rated and then the asset's overall condition or state needs to be determined by summing each element's rating and considering its relative weight or significance. For these asset types, the manuals of operation and specifications provide procedures to calculate the overall condition or state. These assets have various types of distresses, or distinguishable features, which are individually rated and then are combined into a single index, such as geo-hazard index, PCR (Pavement Condition Rating), PCI (Pavement Condition Index), etc.

For the current state of practice, the inspector returns to the project office, downloads the raw data, and calculates the ultimate rating by equations provided by the manuals. However, the disclosed intelligent portable data collection unit is empowered with software analysis capability, which calculates in real-time, and displays a representative condition state index for a selected asset once the condition state of each and all elements are rated and saved by the inspector. For the exemplary pavement landslide in FIG. 4, the unit could use, for example, PCR, PCI, and geo hazard rating index for slope stability analysis.

Therefore, by using this capability, inspectors not only could observe the asset's current condition state, but also could compare that with the available historical data in real-time. This is a unique capability that has never been available to field personnel. The overall condition state index (PCR; PCI) also could be shared with the engineers in the office in real-time and get feedback as might needed in the field.

### D. Portable Data Collector Having a Knowledge Based System

There are many assets, such as, for example, bridge structures, culverts, and retaining walls, where there is no analytical means available to calculate the overall condition state or GA. After the inspector in the field has completed the rating of each and all the elements, the inspector writes down a subjective GA or an overall condition state. This number is entirely subjective and is based on the inspector's experience and field data available to the inspector.

As a means of an over the shoulder (third party) verification of the inspector's subjective rating or to alert the inspector of potential missing data, the disclosed portable data collection unit has been empowered with a knowledge based software program to numerically estimate the overall condition state or the GA of the asset and replace the subjective value with a calculated GA. (see FIG. 5 for Bridge Decks)

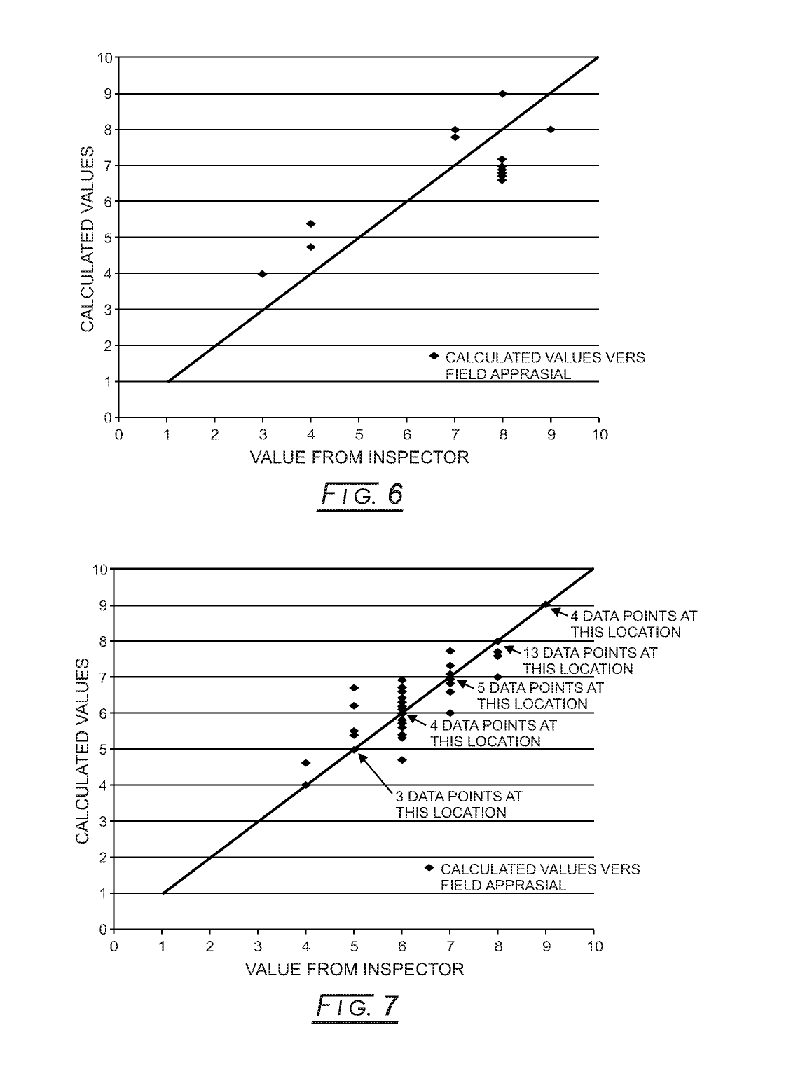

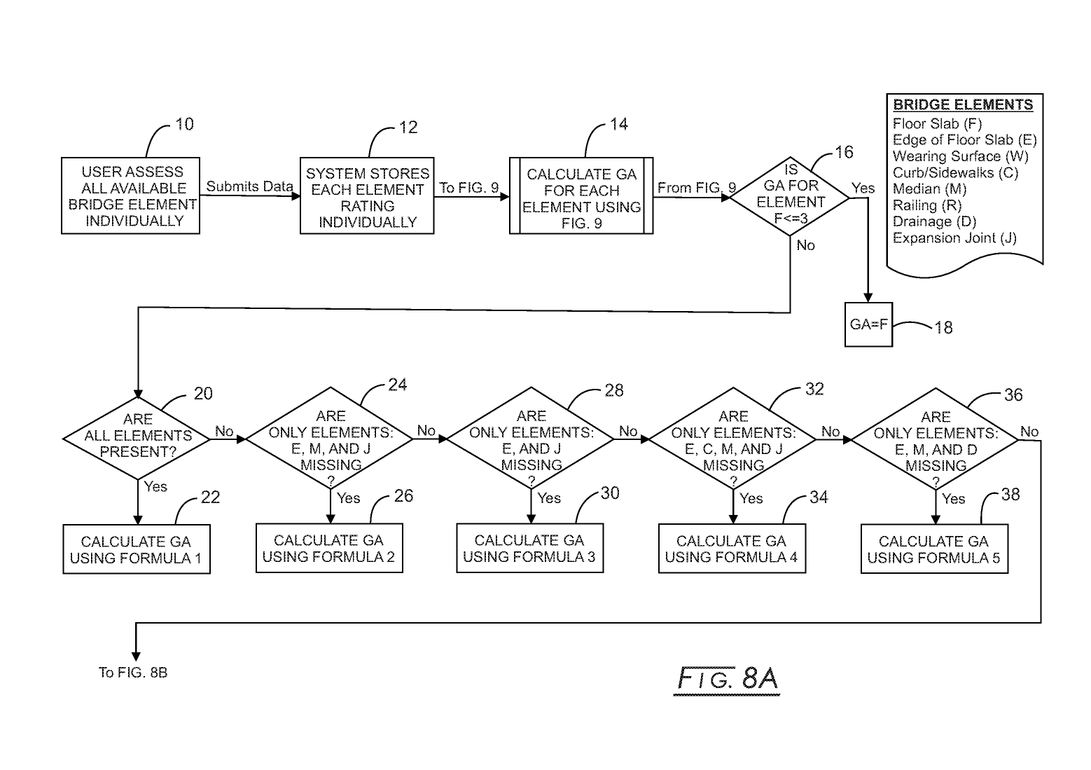

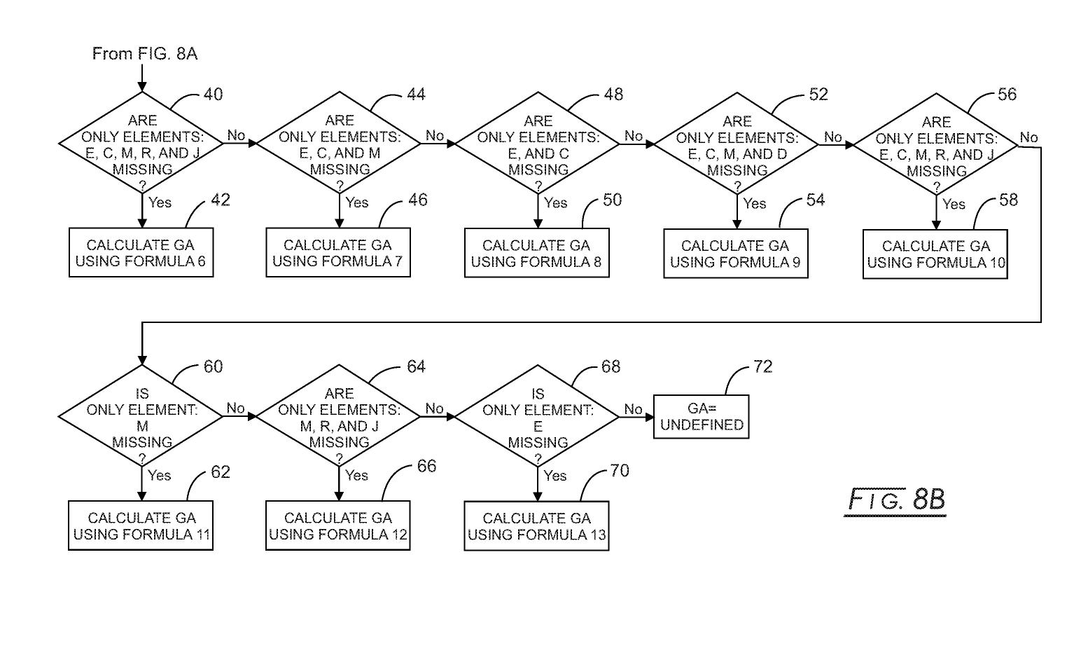

The benefits of this unique capability for the owners, agencies, and engineers include, for example:
Provides a verification and self audit tool; (see FIG. 6)
Challenges inspectors to consider all element conditions to arrive at the ultimate subjection overall condition state of the asset;
Provides available information for the subjective rating to provide an accurate assessment of an asset;
Over the shoulder independent assessment; and
Supervision of the inspection process from the office benefits to from a self-audit check of the rating process.

Analyzing a large number of historical data for bridge and culvert assets, which have been evaluated by experts, inspectors, and engineers, resulted in the knowledge based rating software. Additionally the rating software was instrumental in helping to develop equations to support the experts' subjective ratings.

The condition of each element for the historical assets was rated using AASHTO and DOT (Department of Transportation) manuals with a scale of 1 to 5, and the overall condition state, GA is rated with a scale of 9 to 1. The following presentation and charts demonstrate the verification of the KBS (Knowledge Based System Program) formulas. The rating of these historical data was converted to the current scale of 9 to 1 using KBS software.

D.1 KBs Equations for Bridge Decks

KBs is defined as software using artificial intelligence (AI) expert system techniques in problem solving processes. This disclosure demonstrates the use of KBS by integrating the knowledge of bridge engineering experts in estimating in real time the condition or state of bridge structures. This methodology can be extended to all infrastructure assets.

Bridge decks are composed of the following elements:
Floor Slab (F);
Edge of Floor Slab (E);
Wearing Surface (W)
Curbs/Sidewalks (C);
Median (M);
Railing (R);
Drainage (D); and
Expansion Joint (J).
   National research studies on the subject of bridge deterioration have shown that the General Appraisal Ratings, GA, drops 0.8 to 1.0 GA for each 10 years of structure life. The disclosed KBS considers age as an important input to the decision model, e.g., difference in years between date built and date surveyed.

Various DOT's inspection manuals require that each element is to be rated based on the level of observed distresses, (Low/Medium/High) and its subjective condition state in accordance with each DOT historical rating system, such as, for example, 1 to 5.

The elements with no distress or very minor distress are rated as 1. The Low distress level, L, corresponds to deck degradation of less 5%, the Moderate, M, as 5 to 10%, whereas the high level of degradation, H, is for the deck conditions with 10 to 20% distress.

The condition state rating of (1) for any element corresponds to an excellent condition and the GA ratings of either 9, 8, or 7. The element rating of (2) corresponds to GA rating of either 6 or 5, and the rating of 3, corresponds to GA rating of 4 or 3.

The KBS considers the following logics for the conversion of element condition state ratings to GA values:
Age is less 10 years, NO distress 1=9;
Age less than 30 and NO distress 1=8;
Age less than 30, very minor distress 1=7;
Age >30 years minor distress 1=7;
At Any AGE, Low distress 2=6;
At any Age, moderate M, distress 2=5;
At any age high, and significant distress 3=4;
At any age, Critical condition 4=3; and
The pedestrian bridge deck degradation rates are much slower than highway bridge decks. Therefore, for bridges older than 30 years with low distresses 1=8

If the primary structural elements, such as floor slab, for example, is rated GA=3, the entire structure is considered as GA=3 AND MUST BE REPLACED. In a bridge deck there are eight (8) elements and each element's influence on the overall condition state is significantly different and it is reflected in the KBS equations.

The GA derived from KBS, designated as GA/KBS are based on 13 sets of equations listed below:
1. GA/KBS—All Elements are present: =0.2 F+0.1*E+0.1*W+0.1*C+0.1*R+0.1*M+0.1*D+0.1*J
2. GA/KBS—The elements are NOT present: NO Edge of floor slab, No Median, NO Expansion Joint: =0.4*F+0.3*W+0.1*C+0.1*R+0.1*D
3. GA/KBS—No Edge of Floor Slab, NO Median: =0.2*F+0.3*W+0.1*C+0.1*R +0.1D+0.1J
4. GA/KBS—No Edge, No Curb, No Median, No Joint: =0.4*F+0.4*W+0.1*R+0.1*D
5. GA/KBS—No Edge, No Median, No Drainage: =0.4*F+0.3*W=0.1*C=0.1*R+0.1*J
6. GA/KBS—No Edge, No Curb, NO Median, No Railing, No Expansion Joint: =0.4*F+0.4*W+0.2*D
7. GA/KBS—No Edge, No Curb, No Median: =0.4*F+0.3*W+0.1*R+0.1*D+0.1*J
8. GA/KBS—No Curb, No Median: =0.3*F+0.2*E+0.2*W+0.1*R+0.1*D+0.1*J
9. GA/KBS—No Edge, No Curb, No Median, No Drainage: =0.4*F+0.4*W+0.1*R+0.1*J
10. GA/KBS—No Edge, No Curb, No Median, No Railing. No Expansion Joint: =0.4*F+0.4*W+0.2*D
11. GA/KBS—No Median: 0.4*F+0.1*E+0.1*W+0.1*C+0.1*R+0.1*D+0.1*J
12. GA/KBS—No Median, No Expansion Joint: =0.4F+0.1*E+0.2*W+0.1*C+0.1*R+0.1*D
13. GA/KBS—N Edge of Floor Slab: =0.3*F+0.1*W+0.1*C+0.1*M+0.1*R+0.1*D+0.1*J

The KBS calculated GA numbers, in contrast with the subjective ratings of inspectors, contain decimals. The software has the option of presenting the numbers as calculated or round them up, such as, for example:
4.5 to 5.4=5
5.5 to 6.4=6
6.5 to 7.4=7
7.5 to 8.4=8
8.5 to 9=9

The relationship between the KBS calculated GA and the inspector's subjective ratings for all the deck types and for various deck types separately are compared. The KBS software also identifies those deck structures for which there is a significant difference between the subjective GA values as presented by inspectors and those GA values calculated by KBS software (Equations).

In FIG. 6, these variations in the deck condition states are shown. This self-audit mechanism provides a real-time tool for inspectors and engineers to seek the reason for the non-compliance or unexplained differences between the field and office or simply a quality check.

D.2. KBs/GA Equations for Culverts

Culverts are identified either as structures with less 10 ft., or as a bridge type structure with 10-20 ft. diameter. The asset elements are almost the same in both structures.

The culvert features or elements include:
General, G;
Culvert Alignment, AI;
Shape, SH;
Seams or Joints, SE;
Slabs, SL;
Abutment, AB;
Headwalls, HE; and
Scour, SC.

Similar to the condition rating of deck structures, each culvert element is rated for its condition on a scale of (one) 1, to (five) 5, and the overall condition of the culvert is expressed with a subjective rating known as the General Appraisal, GA ranging from 9 to 1. At the conclusion of inspection the subjective rating GA for that asset is assigned.

As the field data is being saved, the KBS software, in real-time, calculates a KBS GA number for that asset. The KBS software considers “age” and distresses as a part of decision criterion for calculating the KBS/GA rating number. The KBS software equations were developed based on the analysis of large number of structures performed at different time with different experts.

Similar the deck structure, the age criterion is:
Age <(10), 1=9 or no distress;
Age >10 and <30, 1=8 or no distress;
Age >30, (Good), 1=7 or very minor 1 to 5% distress;
Age >30, (fair), 2=6 or 5 to 10% distress;
Age >30 and/or (FAIR), 2=5 or distress 10 to 20%;
Age >30, (POOR), 3=4 or distress >20%;
Age >30, (SERIOUS), 3=3; and
Age >30 or (CRITICAL), 2=4.

As indicated similar to the bridge deck structures, the inspector assigns a subjective appraisal rating GA after completing the survey activities, entering the rating of all elements, and then saving the data.

At this moment, in real-time, the KBS software calculates another GA number to be distinguished as KBS/GA. The KBS/GA has been developed using experts experience on variety of culverts and as many of hundreds. There are a total of (9) nine equations representing the KBS/GA, as follows:
14. KBS/GA EQUATION—All elements present: =0.2*G+0.2*AI+0.2*Sh+0.1*Se+0.1*H+0.1*Sc+0.1*Ab
15. KBS/GA—No Abutment, AI: =0.2*G+0.2*AI+0.2*Sh+0.1Se+0.2H+0.1*Sc
16. KBS/GA—No Scour, No Abutment: =0.2*F+0.3* W+0.1*C+0.1*R+0.1D+0.1J
17. KBS/GA—No Shape, No Seam, No Abutment: =0.3*G+0.3AI+0.3*H+0.1*Sc
18. KBS/GA—No Seam, No Abutment: =0.3*G+0.2*AI+0.2*Sh+0.2*H0.1*Sc
19. KBS/GA—No Shape, No Abutment: =0.3*G+0.3*AI+0.1*Se+0.2*H+0.1*Sc
20. KBS/GA—No Headwall, No Abutment: =0.3*G+0.3*AI+0.2*Sh+0.1*Se+0.1*Sc
21. KBS/GA—No Shape, No Seam, No Abutment: =0.3*G+0.3* AI+0.2*H+0.2*Sc
22. KBS/GA—No Headwall, No Shape, No Abutment: =0.3*G+0.3*AI+0.2*Se+0.2*Sc

In FIG. 7, these variations in the deck condition states are shown. This self-audit mechanism provides a real-time tool for inspectors and engineers to seek the reason for the non-compliance or unexplained differences between the field and office or simply a quality check.

### E. General Appraisal for Bridged Decks—Flow Sheets

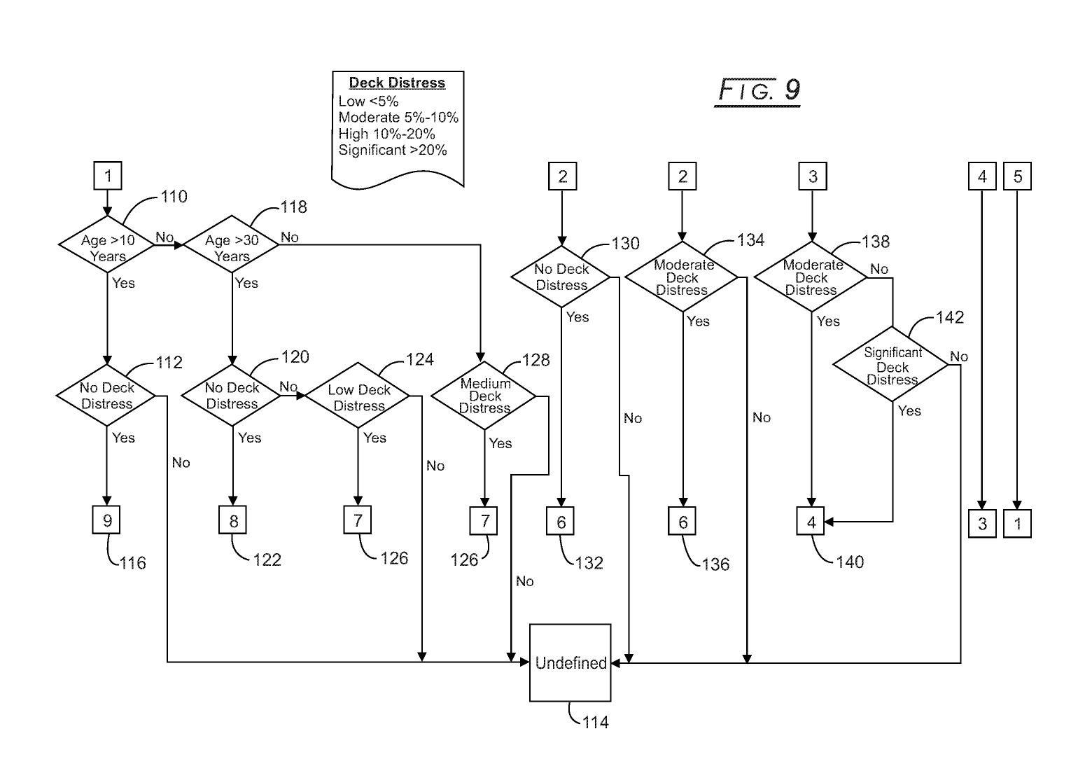

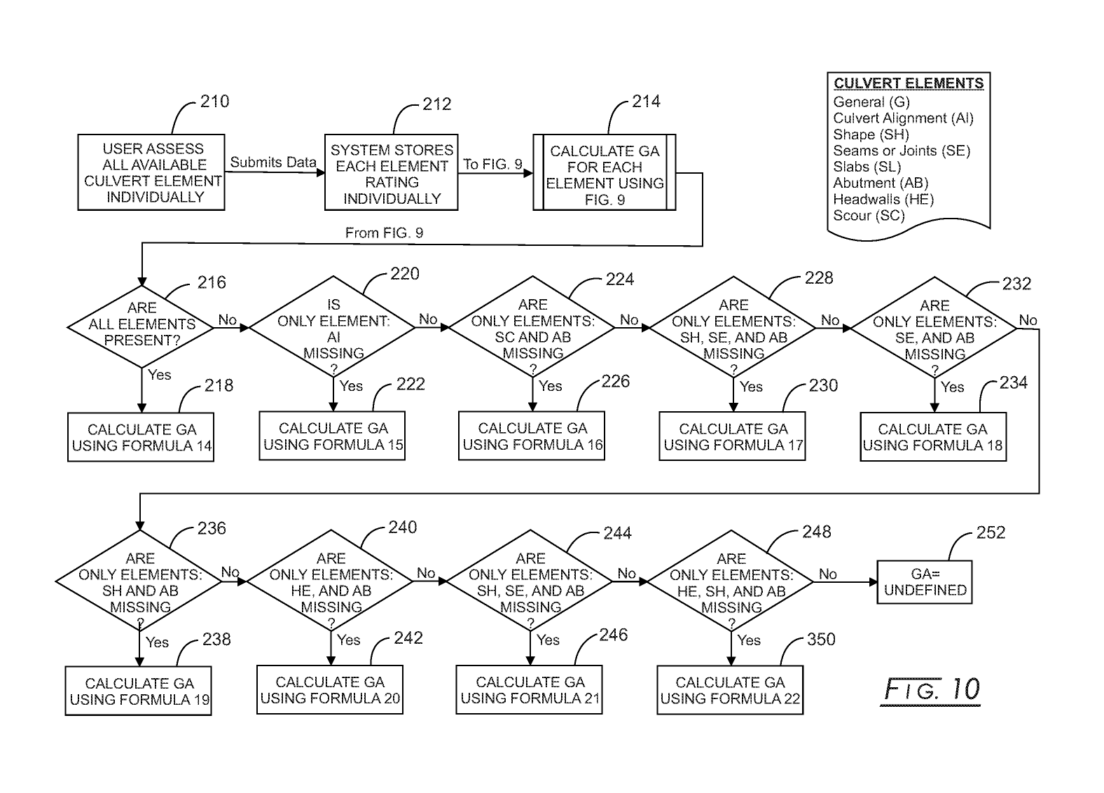

Implementation of the data entry, analysis, and empirical equations disclosed above is set forth in the flow sheets commencing initially with FIG. 8 for bridged decks. In step 10, the user assesses all available bridge elements individually and stores the data in step 12 in the data collector. The flow sheet then proceeds to FIG. 9 in step 110 where the age of the bridge is queried. If the age is less than 10 years, then the flow sheet proceeds to step 112 where the deck distress is queried. If there is no deck distress, the flow sheet proceeds to step 114 where any distress is undefined.

Returning to step 112, if there is deck distress, the flow sheet proceeds to step 116, where a GA value of 9 is assigned. Returning to step 110 if the age of the bridge deck is queried as if the age is less than 30 years. If the age is less than 30 years, the flow sheet continues to step 120 where the deck distress is queried. If the answer is yes, the flow sheet proceeds to step 122, where a GA value of 8 is assigned. If the answer is no, the flow sheet proceeds to step 124 where the query is whether the deck distress is low. If the answer is yes, the flow sheet proceeds to step 126, where a GA value of 7 is assigned.

Returning to step 118, if the query is no, the flow sheet proceeds to step 128, where the query is whether the deck distress is medium. If the answer is yes, the flow sheet proceeds to step 127, where a GA value of 7 is assigned. If the answer is no, the flow sheet proceeds to step 114. If the answer to the medium deck distress in step 128 is no, the flow sheet again proceeds to step 114.

A second branch of the flow sheet queries whether the deck distress is low in step 130. If the answer is yes, the flow sheet proceeds to step 132, where a GA value of 6 is assigned. If the answer is no, the flow sheet proceeds to step 114.

In step 134, the flow sheet queries whether the deck distress is moderate. If the answer is yes, the flow sheet proceeds to step 136, where a GA value of 5 is assigned. If the query is no, the flow sheet proceeds to step 114.

In step 138, the flow sheet queries whether the deck distress is moderate. If the answer is yes, the flow sheet proceeds to step 140, where a GA value of 4 is assigned. If the query is no, the flow sheet proceeds to step 142 where the query is whether the deck distress is significant. If the answer is yes, the flow sheet proceeds to step 140. If the answer is no, the flow sheet proceeds to step 114.

Returning to FIG. 8, the data from FIG. 16 is used to calculate the GA for each element in step 14. If the GA for element F is less than or equal to 3 as queried in step 16, the flow sheet proceeds to step 18 where GA is set to equal F. If the query is step 16 is no, the flow sheet proceeds to step 20, where the query is whether all of the elements are present. If the answer is yes, GA is calculated using Equation 1 in step 22. If the query in step 20 is no, the flow sheet proceeds to step 24 where the query is whether elements E, M, and J are missing. If the answer is yes, the flow sheet proceeds to step 26 where GA is calculated using Equation 2. If the answer is no in step 24, the flow sheet proceeds to step 28, where the query is whether elements E and J are missing. If the answer is yes, the flow sheet proceeds to step 30 where GA is calculated using Equation 3.

If the answer in step 28 is no, the flow sheet proceeds to step 32 where the query is whether elements E, C. M, and J are missing. If the answer is yes, GA is calculated in step 34 with Equation 4. If the answer is no, the flow sheet proceeds to step 36 where the query is whether elements E, M, and D are missing. If the answer is yes, GA is calculated in step 38 using Equation 5. If the answer is no, the flow sheet proceeds to step 40, where the query is whether elements E, C, M, R, and J are missing. If the answer is yes, the flow sheet proceeds to step 42 where GA is calculated using Equation 6.

If the answer in step 40 is no, the flow sheet proceeds to step 44 where the query is whether elements E, C, and M are missing. If the answer is yes, the flow sheet proceeds to step 46 where GA is calculated using Equation 7. If the answer is no, the flow sheet proceeds to step 48 where the query is whether elements E and C are missing. If the answer is yes, the flow sheet proceeds to step 50 where GA is calculated using Equation 8. If the answer is no, the flow sheet proceeds to step 52 where the query is whether Elements E, C, M, and D are missing.

If the answer in step 52 is yes, the flow sheet proceeds to step 54 where GA is calculated using Equation 9. If the answer is no, the flow sheet proceeds to step 56 where the query is whether elements E, C, M, R, and J are missing. If the answer is yes, the flow sheet proceeds to step 58 where GA is calculated using Formula 10. If the answer is no, the flow sheet proceeds to step 60 where the query is whether only element M is missing. If the answer is yes, GA is calculated in step 62 using Equation 11. If the answer is no, the flow sheet proceeds to step 64 where the query is whether only elements M, R, and J are missing.

If the answer in step 64 is yes, the flow sheet proceed to step 66 where GA is calculated using Equation 12. If the answer is no, the flow sheet proceeds to step 68 where the query is whether only element E is missing. If the answer is yes, the flow sheet proceeds to step 70 where GA is calculated using Equation 13. If the answer is no, the flow sheet proceeds to step 72 where GA is undefined.

### F. General Appraisal for Culverts—Flow Sheets

The same type of approach is taken for culverts as has been defined above for bridge decks. Implementation of the data entry, analysis, and empirical equations disclosed above for culverts is set forth in the flow sheets commencing initially with FIG. 10 for bridged decks. In step 210, the user assesses all available culvert elements individually and stores the data in step 212 in the data collector. The flow sheet then proceeds to FIG. 9 again where the general appraisal is done as has been described above with reference to bridge decks.

The flow sheet in FIG. 10, then, proceeds to step 216 where the query is whether all of the elements are present. If the answer is yes, the flow sheet proceed to step 218 where GA is calculated using Equation 14. If the answer is no, the flow sheet proceed to step 220 where the query is whether only element AI is missing. If the answer is yes, the flow sheet proceed to step 222 where GA is calculated using Equation 15. If the answer in step 220 is no, the flow sheet proceeds to step 224 where the query is whether only elements SC and AB are missing. If the answer is yes, the flow sheet proceed to step 226 where GA is calculated using Equation 16. If the answer is yes, the flow sheet proceeds to step 230 where GA is calculated using Equation 17.

If the answer is no in step 228, the flow sheet proceeds to step 232 where the query is whether only elements SE and AB are missing. If the answer is yes, the flow sheet proceeds to step 234 where GA is calculated using Equation 18. If the answer is no, the flow sheet proceeds to step 236 where the query is whether only elements SH and AB are missing. If the answer is yes, the flow sheet proceeds to step 238 where GA is calculated using Equation 19. If the answer is no, the flow sheet proceeds to step 240 where the query is whether only elements HE and AB are missing. If the answer is yes, then the flow sheet proceeds to step 242 where GA is calculated using Equation 20.

If the answer to the query in step 240 is no, the flow sheet proceeds to step 244 where the query is whether only elements SH, SE, and AB are missing. If the answer is yes, the flow sheet proceeds to step 246 where GA is calculated using Equation 21. If the answer is no, the flow sheet proceed to step 248 where the query is whether only elements HE, SH, and AB are missing. If the answer is yes, the flow sheet proceed to step 250 where GA is calculated using Equation 22. If the answer is no, the flow sheet proceeds to step 252 where GA is undefined.

For present purposes, the term “field assets” or “physical assets” (both singular and plural) will be used to refer to the physical structures to be inspected. Such physical structures can be civil or military and include, inter a/ia, transportation facilities, such as, for example, railroad beds, rails, signals, and the like; roadways, including, for example, roadways, berms, signage, curbs, guard rails, and the like; airport facilities, including, for example, runways, lights, signage, and the like; buildings (educational, commercial, industrial, military), including, for example, parking garages, sidewalks, windows, and the like. The term “field assets” should be construed broadly for purposes of the instant disclosure.

While the device (portable field database collector) and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. Also, all citations referred herein are expressly incorporated herein by reference.

We claim:

1. A method for inspecting physical structures for inspection, data condition collection, data administration, analysis, and reporting, which comprises:
(a) inspecting the physical structure;
(b) entering into a mobile data collector with memory, wireless communications, and analysis software, a unique identification indicia of the physical structure including name, identification indicia, global positioning system (GPS) location, condition rating, and color coding based on the condition rating; the unique identification indicia being sent by the wireless communications to a database server;
(c) analyzing with the analysis software based upon the data entered into the mobile data collector and established rating manual criteria, the general appraisal (GA) number for the inspected physical structure.

2. The method of claim 1, wherein for a bridge deck physical structure using the following elements: floor slab (F), edge of floor slab (E), wearing surface (W), curbs or sidewalks (C), median (M), railing (R), drainage (D), and expansion joint (J); the analyzing step includes the following equations for calculating the GA:
1. GA/KBS—All Elements are present: =0.2f+0.1*e+0.1*w+0.1*c+0.1*r+0.1*m+0.1*d+0.1*J;
2. GA/KBS—The elements are NOT present: NO Edge of floor slab, No Median, NO Expansion Joint: =0.4*F+0.3*W+0.1*C+0.1*R+0.1*D;
3. GA/KBS—No Edge of Floor Slab, NO Median: =0.2*F+0.3*W+0.1*C+0.1*R+0.1D+0.1J;
4. GA/KBS—No Edge, No Curb, No Median, No Joint: =0.4*F+0.4*W+0.1*R+0.1*D;
5. GA/KBS—No Edge, No Median. No Drainage: =0.4*F+0.3*W=0.1*C=0.1*R+0.1*J;
6. GA/KBS—No Edge, No Curb, NO Median, No Railing, No Expansion Joint: =0.4*F+0.4*W+0.2*D;
7. GA/KBS—No Edge, No Curb, No Median: =0.4*F+0.3*W+0.1*R+0.1*D+0.1*J;
8. GA/KBS—No Curb, No Median: =0.3*F+0.2*E+0.2*W+0.1*R+0.1*D+0.1*J;
9. GA/KBS—No Edge, No Curb, No Median, No Drainage: =0.4*F+0.4*W+0.1*R+0.1*J;
10. GA/KBS—No Edge, No Curb, No Median, No Railing, No Expansion Joint: =0.4*F+0.4*W+0.2*D;
11. GA/KBS—No Median: =0.4*F+0.1*E+0.1*W+0.1*C+0.1*R+0.1*D+0.1*J;
12. GA/KBS—No Median, No Expansion Joint: =0.4*F+0.1*E+0.2*W+0.1*C+0.1*R+0.1*D; and
13. GA/KBS—N Edge of Floor Slab: =0.3*F+0.1*W+0.1*C+0.1*M+0.1*R+0.1*D+0.1*J

3. The method of claim 2, wherein the age criteria for the bridge deck physical structure includes:
Age is less 10 years, NO distress 1=9;
Age less than 30 and NO distress 1=8;
Age less than 30, very minor distress 1=7;
Age >30 years minor distress 1=7;
At Any AGE, Low distress 2=6;
At any Age, moderate M, distress 2=5;
At any age high, and significant distress 3=4;
At any age, Critical condition 4=3; and
a pedestrian for bridges older than 30 years with low distresses 1=8.

4. The method of claim 1, wherein for a culvert physical structure using the following elements: general (G), culvert alignment (AI), shape (SH), seams or joints (SE), slabs (SL), abutment (SB), headwalls (HE), and scour (SC); the analyzing step includes the following equations for calculating the GA:
14. KBS/GA EQUATION—All elements present: =0.2*G+0.2*AI=0.2*Sh+0.1*Se+0.1*H+0.1*Sc+0.1*Ab;
15. KBS/GA—No Abutment, AI: =0.2*G+0.2*AI+0.2*Sh+0.1Se+0.2H+0.1*Sc;
16. KBS/GA—No Scour, No Abutment: =02*F+0.3*W+0.1*C+0.1*R+0.1D+0.1J;
17. KBS/GA—No Shape, No Seam, No Abutment: =0.3*G+0.3AI+0.3*H+0.1*Sc;
18. KBS/GA—No Seam, No Abutment: =0.3*G+0.2*AI+0.2*Sh+0.2*H+0.1*Sc;
19. KBS/GA—No Shape, No Abutment: =0.3*G+0.3*AI+0.1*Se+0.2*H+0.1*Sc;
20. KBS/GA—No Headwall, No Abutment: =0.3*G+0.3*AI=0.2*Sh+0.1*Se+0.1*Sc;
21. KBS/GA—No Shape, No Seam, No Abutment: =0.3*G+0.3*AI+0.2*H+0.2*Sc; and
22. KBS/GA—No Headwall, No Shape, No Abutment: =0.3*G+0.3*AI+0.2*Se+0.2*Sc.

5. The method of claim 4, wherein the age criteria for the bridge deck physical structure includes:
Age >(10), 1=9 or no distress;
Age >10 and <30, 1=8 or no distress;
Age >30, (Good), 1=7 or very minor 1 to 5% distress;
Age >30, (fair), 2=6 or 5 to 10% distress;
Age >30 and/or (FAIR), 2=5 or distress 10 to 20%;
Age >30, (POOR), 3=4 or distress >20%;
Age >30, (SERIOUS), 3=3; and
Age >30 or (CRITICAL), 2=4.
